(19) United States
(12) Patent Application Publication
(10) Pub. No.: US 2025/0156926 A1
(43) Pub. Date: May 15, 2025

(54) INTEGRATING FEATURED PRODUCT RECOMMENDATIONS IN APPLICATIONS WITH MACHINE-LEARNED LARGE LANGUAGE MODELS (LLMS)

(71) Applicant: Maplebear Inc., San Francisco, CA (US)

(72) Inventors: Haixun Wang, Bellevue, WA (US); Shrikar Archak, Newark, CA (US); Tejaswi Tenneti, San Carlos, CA (US)

(21) Appl. No.: 18/943,691

(22) Filed: Nov. 11, 2024

Related U.S. Application Data
(60) Provisional application No. 63/597,683, filed on Nov. 9, 2023.
(60) Provisional application No. 63/597,894, filed on Nov. 10, 2023.
(60) Provisional application No. 63/598,847, filed on Nov. 14, 2023.

(51) Int. Cl. G06Q 30/0601; G06F 16/9535; G06F 16/955; G06Q 30/08

(52) U.S. Cl. CPC G06Q 30/0631; G06F 16/9535; G06F 16/9558; G06Q 30/08

(57) ABSTRACT

An online system receives a user request from a client device through the interface, identifies one or more featured products based on the query, and generates a prompt for input to a machine-learned generative language model. The prompt specifies both the user's request and a request to suggest the featured products in association with a response to the user request. This prompt is fed into a machine-learned language model via a model serving system for execution. The online system receives a response generated by the model, generates a query response based on the response generated by the model, and transmits instructions to the client device to display the query response. The online system collects data on user interactions with the uses the collected data to fine-tune the machine-learned generative language model.

### CROSS REFERENCE TO RELATED APPLICATIONS

This application claims the benefit of U.S. Provisional Patent Application Ser. No. 63/597,683, filed on Nov. 9, 2023, U.S. Provisional Patent Application Ser. No. 63/597,894, filed on Nov. 10, 2023, and U.S. Provisional Patent Application Ser. No. 63/598,847, filed on Nov. 14, 2023, all of which are incorporated herein by reference in their entirety.

### BACKGROUND

A user can communicate through text-based messaging or voice communication with a chatbot application. Users can interact with chatbots across various platforms: social messaging apps, mobile applications, websites, and even dedicated hardware devices.

A chatbot application may be integrated into an online system. This chatbot can address a wide variety of user queries related to meal planning, recipe suggestions, and cooking advice. When a user poses a question, the chatbot, powered by a large language model (LLM), generates appropriate responses. If a user seeks advice on weekly meal planning, the chatbot might offer a comprehensive meal plan or recommend specific recipes.

Chatbot applications offer users prompt and valuable information in an engaging, conversational manner and a vast knowledge base encoded at least in the millions or billions of parameters, for example, an LLM driving the chatbot application. However, their integration into online platforms can pose challenges. One of the concerns is ensuring the chatbot's recommendations align with the platform's strategic objectives.

In an online system with an integrated chatbot, achieving alignment between the chatbot's suggestion algorithm and the platform's prioritized items presents a technical challenge. The recommendation engine may lack context regarding the platform's evolving featuring priorities or have limited access to real-time data on high-priority items. Additionally, variations in user preferences and query inputs can further complicate the online system's ability to dynamically prioritize featured content, leading to potential misalignment between user-focused recommendations and the platform's prioritized content.

### SUMMARY

Embodiments described herein relate to an online system that solves the above-described problem. The online system is configured to enhance user experience by suggesting featured products based on user's request via an interface for a machine-learned generative language application.

Responsive to receiving a user query from a client device and via an interface, the online system generates a prompt for input to a machine-learned generative language model. The prompt specifying at least a request related to the user query and a request to suggest one or more featured products in association with a response to the prompt. This prompt is provided to a model serving system for execution by the machine-learned generative language model.

In some embodiments, the prompt includes a list of featured products. In some embodiments, the prompt further includes data describing the list of featured products. Alternatively, or in addition, data describing the list of featured products are indexed in an index document (e.g., LlamaIndex™ or LangChain™), causing the machine-learned language model to consider both the index document and the prompt in generating the response.

The online system receives a response generated by executing the machine-learned generative language model on the prompt and generates a query response to the user query. The query response includes at least a suggestion for the one or more featured products. The online system transmits instructions, to the client device, to cause display of the generated query response to the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method of suggesting featured products based on user requests, in accordance with one or more embodiments.

FIG. 4A illustrates an example prompt generated by an online system based on a user request, in accordance with one or more embodiments.

FIG. 4B illustrates an example response generated by an LLM based on the prompt of FIG. 4A, in accordance with one or more embodiments.

FIG. 5A illustrates another example prompt generated by an online system based on a user request, in accordance with one or more embodiments.

FIG. 5B illustrates an example response generated by an LLM based on the prompt of FIG. 5A, in accordance with one or more embodiments.

FIG. 6 is a flowchart for a method of suggesting featured products based on user requests.

FIG. 7 illustrates an example bidding process in accordance with one or more embodiments.

FIG. 8 illustrates an example user interface configured to receive user requests and present search results to users, in accordance with one or more embodiments.

FIG. 9 illustrates another example user interface that presents search results to users in accordance with one or more embodiments.

FIG. 10 is a flowchart for a method of responding to user requests with a brand-specific promotion in accordance with one or more embodiments.

FIG. 11 is a flowchart for another method of responding to user requests with a brand specific promotion in accordance with one or more embodiments.

### DETAILED DESCRIPTION

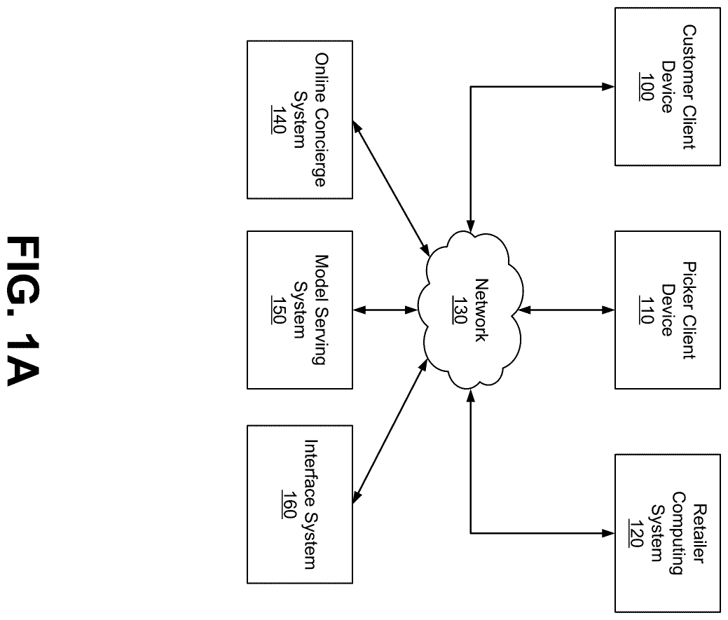

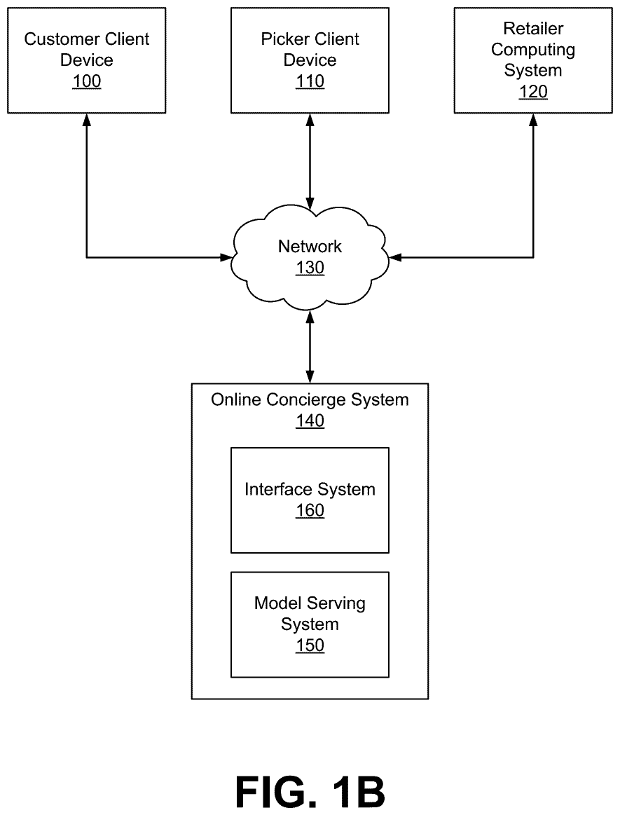

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. In some embodiments, the online system 140 may be an online concierge system. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1A or 1B, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

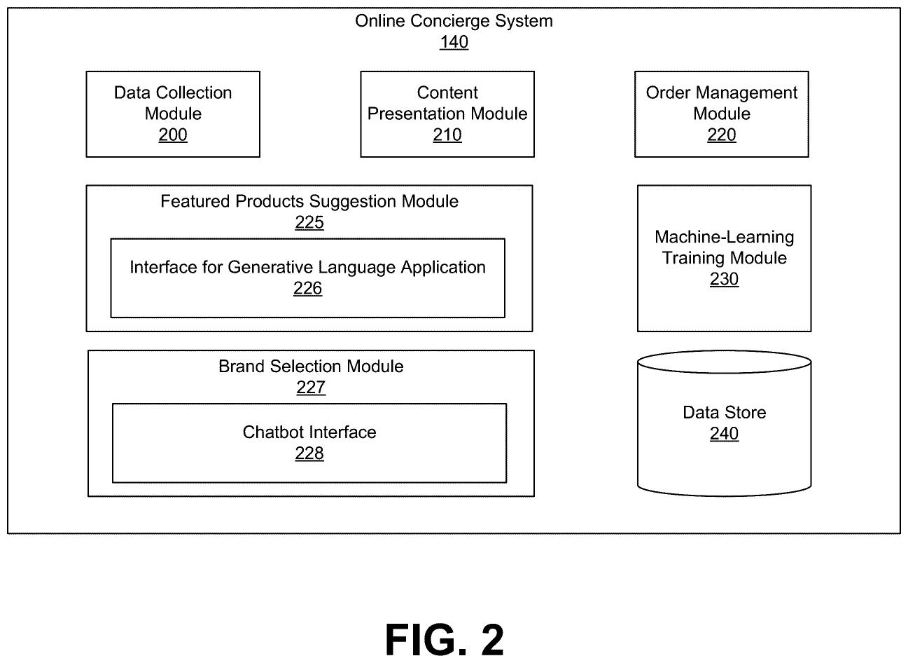

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 interacts with an interface for a generative language application 226, e.g., a chatbot application, a Question and Answer (Q/A) search box, and a general search box to address various tasks within the online system 140. In one or more embodiments, the task is synthesizing a response to a user query to the online system 140. In the disclosure described herein, the online system 140 identifies a promotion opportunity when the online system 140 is applying a chatbot, and presents one or more featured products as part of the response to a user query that was obtained from the response from the chatbot application.

The online system 140 receives, from a client device, a user query and generates a prompt for input to a machine-learned language model (e.g., an LLM). In one or more embodiments, the online system 140 prompts the chatbot application to create opportunities to promote or inject featured items in the response. For example, the prompt specifies at least the user query and a request to suggest one or more featured products in association with a response to the user query. The online system 140 provides the prompt to a model serving system 150 for execution by the machine-learned language model. The machine-learned language model is executed on the prompt to generate a response. The response includes the response to the user request and a suggestion for the one or more featured products in association with the response to the user request. The generated response is then sent back to the model serving system 150, which causes the response to be presented to the client device via an interface.

In some embodiments, the prompt may include one or more featured products, and/or data describing one or more featured products. The data describing the featured products may include names and descriptions of the products. In some embodiments, the data describing featured products are indexed into an index document, causing the LLM to consider both the prompt and the index document in generating the response. In some embodiments, the index document is generated based on LlamaIndex™. In some embodiments, the index document is generated based on LangChain™.

In some embodiments, the generative language application may include a Question and Answer (Q/A) module configured to receive questions from users, and generate answers to the received questions. In some embodiments, the generative language application may be configured to recommend recipes and meal plans that include featured products. In some embodiments, the suggestion for the one or more featured products may include product descriptions, or a landing page of a product.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a featured products suggestion module 225, a brand selection module 227, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

Integrated Featured Product Recommendation with LLM

In some embodiments, the featured products suggestion module 225 receives user queries users submitted via, for example, an interface of an online system 140. For example, the user queries may be search queries the user submits via a search interface to retrieve related items to the user query. In one or more embodiments, the featured products suggestion module 225 communicates with a LLM-based application (e.g., chatbot application, Q/A application) to synthesize a response to the user query. In some embodiments, the response to the user query is a list of relevant items. In other embodiments, the response to the user query is a natural language response describing an item or brand.

Responsive to receiving a user query, the featured products suggestion module 225 generates a prompt for input to a machine-learned language model (e.g., an LLM). The prompt includes at least two parts. The first part specifies a request based on the user query, and the second part specifies a request to suggest one or more featured products in association with a response to the user query.

In some embodiments, the prompt includes one or more featured products and/or data describing one or more featured products. Below is an example prompt generated based on a user query for a recipe for vegan stir fry, and one or more featured products including ABC Co. light bulb, Tasty Brand tofu, and XYZ Inc pasta sauce. The prompt also specifies that an ad should be displayed only if it is relevant to the response to the user's original request.

Show me a recipe for vegan stir fry. Also, as if showing an ad, suggest the user to consider any of the items listed wherever relevant:
1. ABC Co. light bulb,
2. Tasty Brand tofu,
3. XYZ Inc. pasta sauce,
   Show the suggestion only if it's relevant to the recipe.

In some embodiments, the prompt asks the LLMs to take on the persona of a salesperson and generate creative suggestions explaining the connection between the original user query and the featured products. Below is an example prompt generated based on a user query for a chicken recipe.

Could you create a chicken recipe? Also as if showing an advertisement, suggest customers to consider either of the following three: 1. HealthBest Brand Mango Juice, 2. Tasty Brand Cola, 3. ABC Co. Gelato Layers Strawberry Shortcake.

Once an LLM deployed on the model serving system 150 receives the prompt, it generates a response including at least two parts. The first part includes a response to the user request, and the second part includes a suggestion for the one or more featured products in association with the response to the user request. The one or more featured products may be sponsored products. In certain instances, the first part (including the response to the user request) and the second part (including suggestions) are intertwined in the response. Especially, when the featured products are relevant to the response, integrating them seamlessly can potentially offer value to the user, making advertising opportunities less intrusive or disruptive.

In some embodiments, the featured products are provided as part of the response to the user query, e.g., become an ingredient of a recipe. In some embodiments, the featured products are embedded in line or between lines of the response to the user request.

For example, responsive to receiving the above prompt about a recipe for vegan stir fry, the LLM may generate the following response:

### Instructions:

1. Heat 1 tbsp of vegetable oil in a large pan or wok over medium-high heat, add the cubed Tasty Brand Tofu and cook, stirring occasionally, until golden brown on all sides. Remove tofu from the pan and set aside.
   Ad: Tasty Brand Tofu—delicious, high-quality tofu perfect for all your vegan recipes. Try Tasty Brand Tofu today for the perfect addition to your stir fry!
2. In the same pan, add another tbsp of vegetable oil. Add the sliced bell pepper, onion, and . . . .

As shown above, among the list of featured products, namely ABC Co. light bulb, Tasty Brand Tofu, and XYZ inc. pasta sauce, the LLM selected Tasty Brand Tofu as the relevant product. In particular, the response includes a recipe including Tasty Brand Tofu as an ingredient. Further, between the first step and second step of the recipe, an advertisement describing Tofu is also inserted.

In some embodiments, the featured products are provided as additional suggestions in addition to the response to the user request. For example, responsive to receiving the above prompt about a chicken recipe, the LLM may generate the following response:

Honey Mango Glazed Chicken instructions . . . .
To enhance your dining experience, we recommend pairing your Honey Mango Glazed Chicken with one of the following options:
1. HealthBest Mango Juice: Refresh your palate with a glass of HealthBest Mango Juice, complementing the fruity flavors of the chicken glaze and providing an invigorating boost to your meal.
2. Tasty Brand cola: For a classic and satisfying choice, enjoy an ice-cold Tasty Brand cola alongside your Honey Mango Glazed Chicken. The effervescence and sweetness of the Coke will contrast and balance the savory and spicy elements of the dish.
3. ABC Co. Gelato Layers Strawberry Shortcake: To end your meal on a sweet and indulgent note, treat yourself to a serving of ABC Co. Gelato Layers Strawberry Shortcake. The creamy gelato and fruity strawberry layers will be a delightful contrast to the zesty chicken, rounding off a perfect dining experience.

As shown above, the list of featured products is presented to users as separate suggestions.

In some embodiments, the response from the LLM is passed onto the user directly. For example, the example responses described above may be presented in conjunction with a recipe page generated for the user. Alternatively, or in addition, the response from the LLM is further processed, and the processed response is then passed onto the user. For example, the featured items may further be linked with ULRs, corresponding to a featured product page. As another example, the featured items may be coupled with an interactive element, allowing the user to add it to the user's shopping cart. For example, the suggested featured items may be presented in the recipe page along with other items corresponding to the ingredients in the recipe page such that the user can click the featured product and add it to the user's order.

In some embodiments, the featured products suggestion module 225 operates in a batch mode, in which the generative language application accumulates all the user requests received in a time frame, and batch processes them altogether. In some embodiments, the generative language application operates in a real time mode, in which the generative language application generates a response for each user request in near real time.

In some embodiments, the one or more featured products are selected based on a bidding process. In some embodiments, the product suggestion is generated in line along with the response to the original user query.

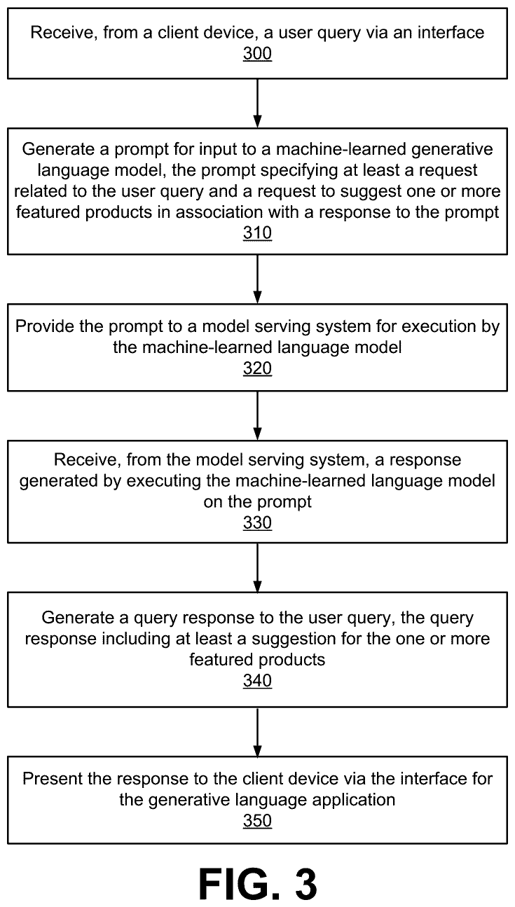

FIG. 3 is a flowchart for a method of suggesting featured products based on user requests. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives 300, from a client device, a user query via an interface, for example, a search query. The online system 140 generates 310 a prompt for input to a machine-learned generative language model (e.g., LLM). In some embodiments, the online system provides an interface that is a generative language application. In some embodiments, the generative language application may be a chatbot, a Q/A search box, or another suitable type of search box.

The online system 140 may generate 310 a prompt specifying at least a request based on the user query and a request to suggest one or more featured products in association with a response to the user query. In some embodiments, the prompt includes a list of featured products. For example, the prompt of the vegan stir fry recipe and the chicken recipe described above both include a list of featured items. In some embodiments, the prompt further includes data describing the list of featured products. In some embodiments, the data describing the list of featured products are indexed into an index document. In some embodiments, the index document is generated based on LlamaIndex™. In some embodiments, the index document is generated based on LangChain™. The LLM is caused to consider both the prompt and the index document when generating the response. In some embodiments, the prompt includes a request for the LLM to generate a promotion opportunity for a featured product only when the featured product is relevant to the response to the original user query. For example, the prompt for the vegan stir fry recipe described above includes a request to show an ad wherever relevant to the featured products.

Once the prompt is generated, the online system 140 provides 320 the prompt to a model serving system 150 for execution by the machine-learned language model. Responsive to receiving the prompt, the machine-learned language model is caused to generate a response based on the prompt. The response includes at least a suggestion for the one or more featured products in association with the response to the prompt.

In some embodiments, the LLM is configured to embed suggestions in line with the response to the original user request. For example, as the response for the chicken recipe described above, the LLM is caused to generate a recipe, and also generate suggestions separate from the recipe, describing connections between the recipe and the featured item, and why they can be consumed together.

The model serving system obtains the response from the LLM and passes the response to the online system 140. Responsive to receiving 330 the response from the model serving system, the online system 140 generates 340 a query response to the user query. The user query response including at least a suggestion for the one or more featured products, and presents 350 the response to the client device via the interface for the generative language application.

In some embodiments, the online system 140 simply passes the response to the client device. Alternatively, the online system 140 further processes the response before sending it to the client device of the user. For example, in some embodiments, the online system 140 may insert an image and/or a hyperlink, e.g., URL (uniform resource locator) of the featured items into the response, enabling the user to directly interact with the one or more featured products from within the response. In some embodiments, the online system 140 may also add an interactive element to the response, allowing the user to add the featured items to a shopping cart. In some embodiments, the online system collects data on user interactions with the featured items, e.g., whether or not the user adds a featured item to their shopping cart. The collected user interactions may then be used to improve future recommendations. In some embodiments, the data on user interactions may be used to retrain and/or fine-tune a machine-learned model that predicts the click-through rate (CTR) for each product. This prediction helps prioritize items more likely to engage user effectively, giving an advantage to products with higher CTR potential. Alternatively, or in addition, the data on user interactions may be used to retrain and/or fine-tune the machine-learned language model.

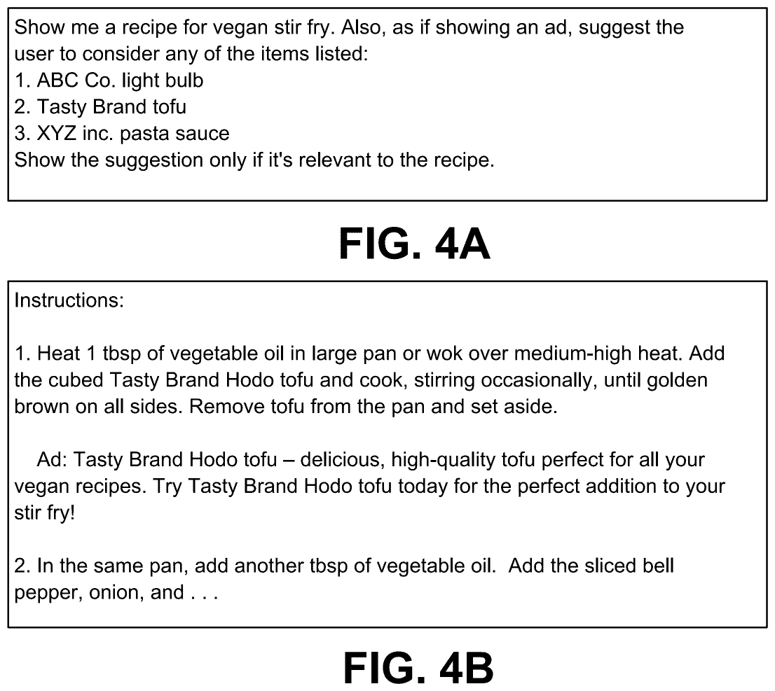

FIG. 4A illustrates an example prompt generated by an online system 140 based on a user request in accordance with one or more embodiments. As illustrated, the prompt includes two parts. The first part includes “show me a recipe for vegan stir fry.” This part is generated based on the original user request. In some embodiments, this part is the original user request. Alternatively, the online system 140 may process the original user request to extract semantic meanings and generate a new request based on the extracted semantic meanings. The second part includes a request for the LLM to suggest the user to consider any of a list of featured products. In some embodiments, a subset of featured products are included based on the semantic meanings of the original user query. Alternatively, all the featured products are included in the prompt. As such, the second part may or may not be customized based on the original user query.

FIG. 4B illustrates an example response generated by an LLM based on the prompt of FIG. 4A in accordance with one or more embodiments. As illustrated, the response also includes two parts, corresponding to the two parts of the prompt. The first part of the response includes a response to the user query (which is the first part of the prompt). The first part of the response includes instructions for a vegan stir fry recipe. The second part of the response includes a response to the request for one or or more suggestions (which is in the second part of the prompt). In particular, the second part of the response includes a suggestion to use Tasty Brand Tofu, which is one of the featured items in the second part of the prompt. Here, the second part of the response (e.g., an ad) is woven subtly into the first part of the response (e.g., a response to the original user request), making the suggested products less intrusive or disruptive, thus enhancing user experience and increasing click through rates (CTR). The response may be integrated into a recipe page displayed on the user's client device, and the user may be presented with a set of items from a retailer that include items corresponding to the ingredients and also the suggested items.

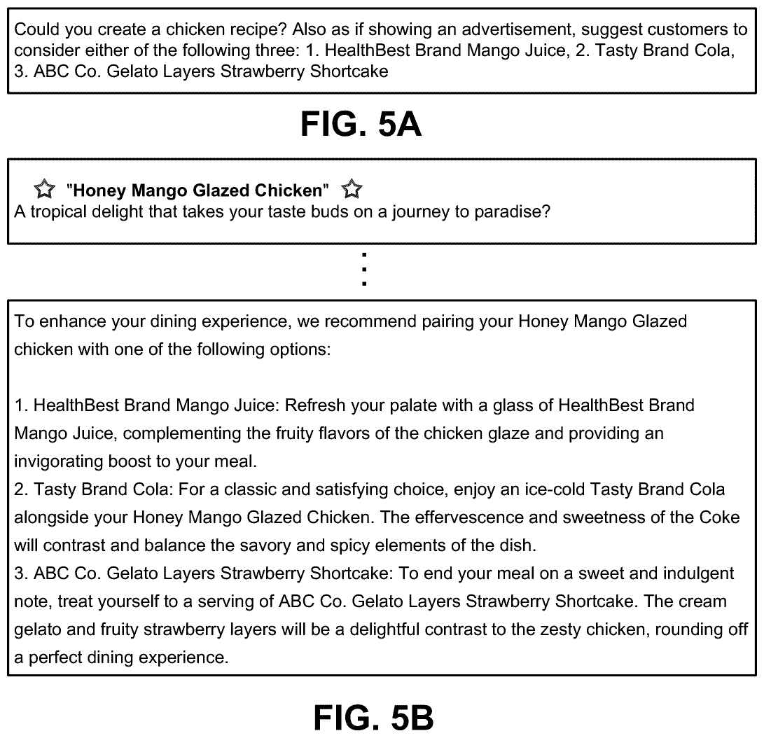

FIG. 5A illustrates another example prompt generated by an online system based on a user request in accordance with one or more embodiments. As illustrated, the prompt also includes two parts. The first part includes “Could you create a chicken recipe?” This part is generated based on the original user request. The second part includes a request to show an advertisement, suggesting customers consider a list of three featured items. Unlike the second part of the prompt shown in FIG. 4A, which requires an ad of a featured product to be relevant to the recipe (which is the response to the original user response), here, the prompt simply asked LLM to suggest customers consider the featured products.

FIG. 5B illustrates an example response generated by an LLM based on the prompt of FIG. 5A in accordance with one or more embodiments. As illustrated, the response also includes two parts, corresponding to the two parts of the prompt. The first part of the response includes a Honey Mango Glazed Chicken recipe, corresponding to the user request (which is the first part of the prompt). The second part of the response includes a response to the request for an ad (which is the second part of the prompt). In particular, the second part of the response includes suggestions to each of the featured products, describing their connections to the Honey Mango Glazed Chicken. Here, unlike the response shown in FIG. 4B, in which the first part and second part of the response are intertwined; here, the first part and second part of the response are apart from each other.

### Prompt Hints to LLM to Include CPGs in Response

Monetization in online platforms, especially ones that provide a personalized service, has long been a challenge.

However, they come with inherent challenges that can adversely impact both the user experience and the effectiveness for advertisers. From the user's perspective, these traditional formats often prove to be intrusive and interruptive. Banner ads can clutter a webpage, diverting attention from the user's primary purpose for visiting the site. Video ads, particularly pre-roll or mid-roll types, disrupt the flow of content, potentially driving users away. Furthermore, sponsored products may not always align with individual user interests, diluting the overall browsing experience. The excess of ads can lead to “banner blindness,” where users instinctively ignore ad content, while the use of tracking technologies for targeting can raise privacy concerns.

Embodiments described herein relate to an online system that solves the above-described problem. The online system 140 receives a user query from a client device and generates a prompt for input to a machine-learned language model. The prompt specifies at least a request based on the user query and a request to include one or more consumer packaged good (CPG) products in a response from the LLM. In one or more embodiments, this prompt is executed by the machine-learned language model through a model serving system 150. The response is parsed to extract the one or more CPG products, which are then matched with featured products in a database. These matched, featured products are subsequently presented to the user in response to the user's request.

In some embodiments, selecting one or more featured products includes, for each of the one or more CPG products, identifying one or more featured products that match the one or more CPG products, conducting a sponsorship auction among one or more feature products, and selecting one or more top bidders among the one or more feature products for presentation to the user.

In some embodiments, the online system 140 further conducts a search on the one or more CPG products and presents both search results and the selected one or more featured products to the user as a response to the user query.

When a search term is received, an online system may generate a generic prompt, and causes the generic prompt to be executed by the machine-learned language model (e.g., LLM) through the model serving system. When such a generic prompt is executed, the language model often generates results that are not aligned with the online system 140's broader goals.

For example, when a search term from a user includes “Salmon”, the online system 140 generates a generic prompt, e.g., “What goes well with Salmon?” to synthesize a response of recommended items to the user. This prompt may result in a response including a list of generic products, including lemon, dills, capers, garlic, butter, white wine, and parsley. As another example, when a search term includes “tortilla chips,” the online system 140 generates a prompt, e.g., “What goes well with tortilla chips?” This generic prompt will result in a response including a list of generic products, including salsa, avocado, cheese dip, refried beans, sour cream, and chili.

Even though the generic products are related to the search terms, they often are not directly linked to featured products that are offered on the online system 140 and/or sponsored by one of the retailers or manufacturers. One of the reasons that many generic items created from general prompts are not linked to featured products is that most generic items are not Consumer Packaged Goods (CPG), whereas the majority of featured products are CPGs. In one instance, advertisers of featured items can participate in keyword bidding, where an ad auction (or any type of sponsored content including images, text, videos, etc.) can be held anytime a user searches or is provided a response that includes one or more keywords. When generic items are used in the response, advertisers may lose opportunities to bid on certain items, since the keyword for the CPG does not appear in the response. By hinting the LLM to respond using CPG words or phrases wherever possible, the online system 140 creates additional opportunities for advertisers to bid for sponsored content. A bidder can indicate their bid amount for a particular featured product associated with a particular response to a user query. A bid amount is a value indicating a priority for having a corresponding featured product to be suggested to the user within the response to the user request.

The online system 140 described herein solves the above-described technical problem by generating a prompt including both a request related to the user query and a request to include one or more consumer packaged good (CPG) products in a response. For example, when the search term is “salmon,” the prompt may be “What goes well with salmon but are also advertised or CPG products?” This prompt will result in the following response: “Some CPG products that go well with salmon include lemon juice, olive oil, capers, garlic, herbs, and spices. Other popular accompaniments include rice, potatoes, vegetables, and salads.” Notably, unlike the response generated based on the generic request, the response here includes “lemon juice” and “olive oil,” which are CPG products, instead of lemon and dill, which are not CPG products.

As another example, when the search term is “tortilla chips,” the prompt may be “What goes well with tortilla chips but are also advertised or CPG products?” This prompt will result in the following response: “Some popular CPG products that go well with tortilla chips include salsa, guacamole, queso dip, sour cream, refried beans, and jalapenos. Other snacks that pair well with tortilla chips include nachos, cheese sticks, and jalapeno poppers. Beverages such as beer, margaritas, and soft drinks are also popular accompaniments to tortilla chips.” Again, the avocado and cheese dip in the generic response are replaced with “guacamole” and “queso dip.” Furthermore, the response here includes additional CPG products, from snacks to beverages.

The response generated by the machine-learned language model is received from the model serving system 150. The online system 140 parses the response to extract the CPG products, which are then matched with featured products in a database. In some embodiments, the featured products are stored in the data store 240. These matched, featured products are subsequently presented to the user in response to the user's query. In some embodiments, each featured product is associated with one or more sponsored content items. The sponsored content items corresponding to the matched featured products are presented to the user in response to the user's query. In some embodiments, the sponsored content items are stored with their respective featured products relationally in the data store 240.

The featured products suggestion module 225 may receive a user query from a client device and generate a prompt for input to a machine-learned language model (e.g., an LLM). The prompt specifies at least a request obtained from the user query and a request to include one or more consumer packaged good (CPG) products in a response. This prompt is executed by the machine-learned language model to generate a response.

In some embodiments, the featured products suggestion module 225 provides a user interface that allows users to submit queries. The user interface may include a search box configured to receive one or more search terms. Responsive to receiving the search term, the featured product suggestion module 225 generates a prompt based on the search term to synthesize a response to the user query.

Alternatively, the user interface may be a chatbot or question/answer box. For example, when a user asks “how to make pasta” via the user interface, the featured products suggestion module 225 generates a prompt, causing the LLM to generate a response. The prompt may be “How to make pasta using CPG products?” The response may include pasta, pasta sauce, and olive oil.

The featured products suggestion module 225 parses the response from the LLM to extract one or more CPG products. For example, in the salmon request, the featured products suggestion module 225 may extract lemon juice, olive oil, capers, garlic, herbs, and spices as related CGP products. For the tortilla chips request, the feature product suggestion module 225 may extract salsa, guacamole, queso dip, sour cream, refried beans, jalapenos, nachos, cheese sticks, jalapeno poppers, beer, margaritas, and soft drinks as related CGP products. For the pasta request, the feature product suggestion module 225 may extract pasta, pasta sauce, and olive oil as related CGP products.

Alternatively, or in addition, the featured products suggestion module 225 may further select one or more featured products that match at least one of the one or more CPG products, and present the one or more featured products to the user as a response to the user request.

In some embodiments, for each of the CGP products, the featured products suggestion module 225 may access a sponsored content server to retrieve relevant sponsored content items. Each relevant sponsored content item has a predicted click-through rate, which is a metric used to predict a probability of a user clicking on the sponsored content item. The relevant sponsored content items then go through a bidding process where different content providers compete to have their sponsored content items displayed for the given CPG product.

For example, when the CGP products include pasta, pasta sauce, and olive oil, for each of these CGP products, the featured products suggestion module 225 goes through the above-described process to retrieve relevant sponsored content items, and predicts a click-through rate and go through a bidding process for each sponsored content item. The winner of the sponsored content items will be presented to the user.

The content items may be presented in different views, such as list view, grid view, carousel view, etc. In a list view, items are usually displayed in a vertical column, showing essential details like the product name, price, and a thumbnail image. In a grid view, multiple items are displayed side-by-side, typically in a grid format. This view usually shows a picture of the item, its name, and the price. In a carousel view, items are presented in one or more carousels horizontally or vertically, and users can scroll through the items horizontally or vertically. In some embodiments, for each CGP product in the response, a carousel is generated and presented to the user. Each carousel shows all the sponsored content associated with featured products corresponding to a particular CGP product. For example, when the CGP products include pasta, pasta sauce, and olive oil, three carousels may be generated and presented to the user. A first carousel includes sponsored content items associated with pasta, a second carousel includes content items associated with pasta sauce, and a third carousel includes content items associated with olive oil.

In some embodiments, the online system 140 conducts a search over the CPG products, and the sponsored content items are presented with the search results. In some embodiments, the sponsored content items and the search results are intertwined with each other. In some embodiments, the search results are presented in one section of the user interface, and the sponsored content items are presented in another section of the user interface. For example, the search results may be presented in grid view at a first portion of the user interface, and the sponsored content items are presented in carousels above, below, or between the grids of the search results.

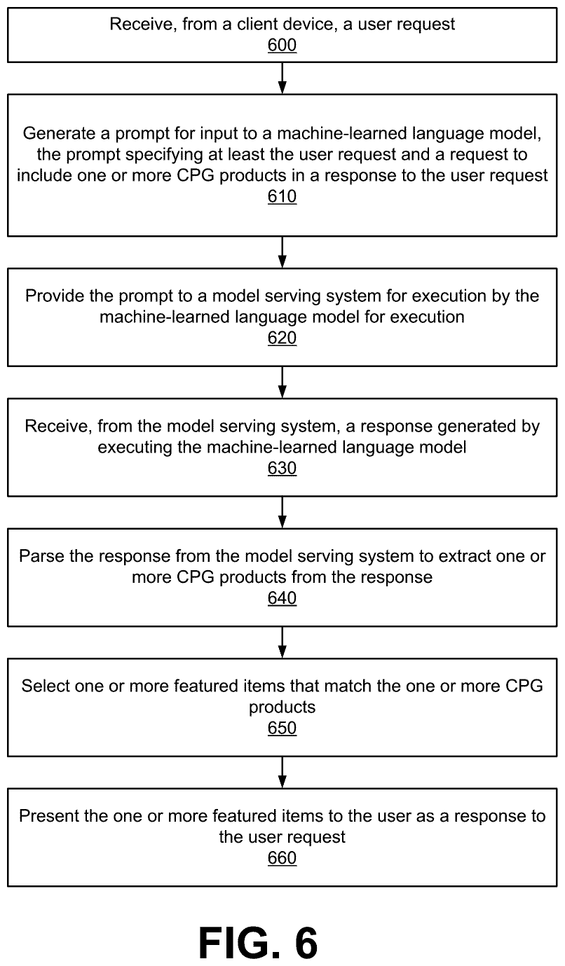

FIG. 6 is a flowchart for a method of suggesting featured products based on user requests. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

The online system 140 receives 600, from a client device, a user query. The online system 140 generates 610 a prompt for input to a machine-learned language model. The prompt specifies at least a request based on the user query and a request to include one or more CPG products in a response to the user query.

The online system 140 provides 620 the prompt to a model serving system for execution by the machine-learned language model (e.g., an LLM) for execution. The machine-learned language model is applied to the prompt to generate a response. The online system 140 receives 630 the response. The response includes one or more CPG products. The online system 140 parses 640 the response from the model serving system to extract one or more CPG products from the response. The online system 140 selects 650 one or more featured products that match the one or more CPG products and presents 660 the one or more featured products to the user as a response to the user request. In some embodiments, the online system collects data on user interactions with the featured products, e.g., whether or not the user adds a featured product to their shopping cart. The collected user interactions may then be used to improve future recommendations. In some embodiments, the data on user interactions may be used to retrain and/or fine-tune a machine-learned model that predicts the click-through rate (CTR) for each product. This prediction helps prioritize items more likely to engage user effectively, giving an advantage to products with higher CTR potential. Alternatively, or in addition, the data on user interactions may be used to retrain and/or fine-tune the machine-learned language model.

In some embodiments, selecting the one or more CPG products includes a bidding process that is an auction-like process. An ad request with a CPG product is sent out. Interested advertisers submit their bids including the price they are willing to pay to display their content items, which may be performed automatically by an application. The highest bidder usually wins the right to display their content item to the user. This may all happen in a matter of several milliseconds.

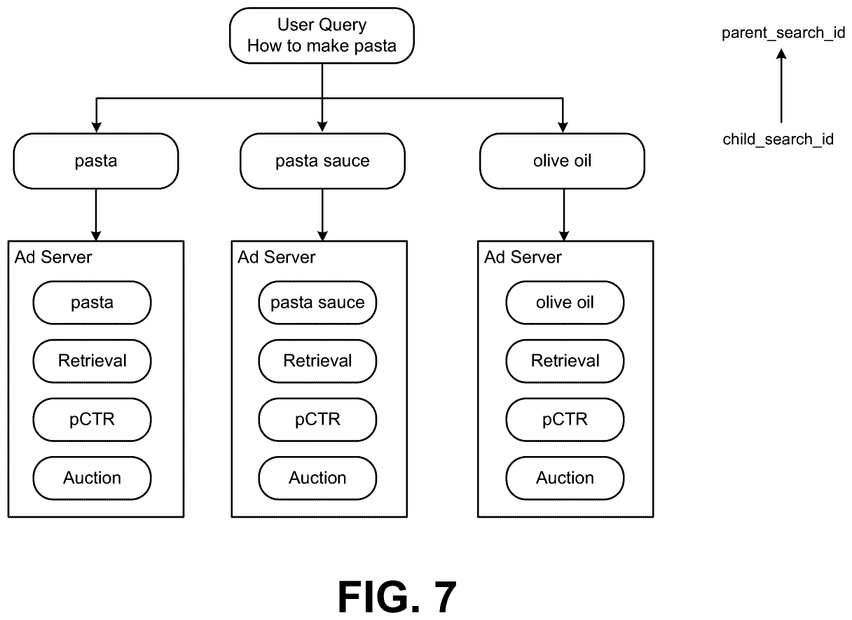

FIG. 7 illustrates an example bidding process 700 in accordance with one or more embodiments. As illustrated in FIG. 7, a user query includes “how to make pasta.” Responsive to receiving the user query, the online system 140 generates a prompt for an LLM, and receives a response from the LLM. The response includes three CPG products, namely pasta, pasta sauce, and olive oil. Notably, the original user query, “how to make pasta,” corresponds to a parent search ID, and the response includes three CPG products, namely pasta, pasta sauce, and olive oil (each corresponds to a child search ID).

For each of the child search IDs, a bidding process may be performed. For example, the child search ID “pasta” goes through a bidding process, including retrieving sponsored content items relevant to “pasta,” determining a predicted click-through rate (pCTR), and requesting the relevant sponsored content items to go through the auction process to identify a highest bidder. The sponsored content item of the highest bidder will be presented to the user. Similarly, each of the child search IDs “pasta sauce” or “olive oil” also goes through the same process to identify a highest bidder. As such, the highest bidders of each child search IDs, pasta, pasta sauce, and olive oil will be presented to the user.

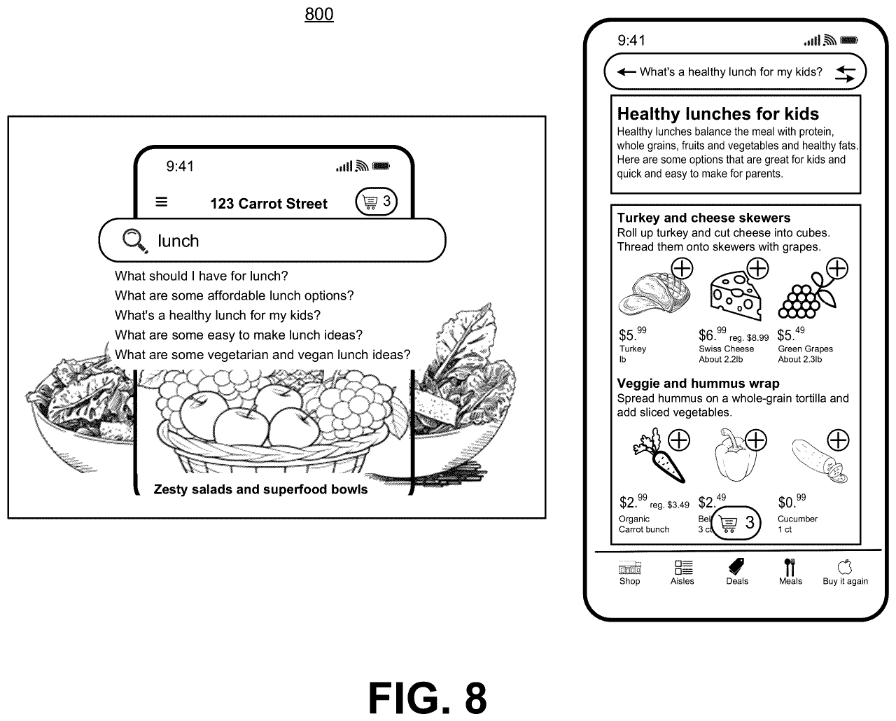

FIG. 8 illustrates an example user interface configured to receive user requests in accordance with one or more embodiments. This user interface includes a search box or a Q/A box, allowing users to input search terms or questions. For example, if a user enters “what's a healthy lunch for my kids?”, the online system 140 generates a prompt for an LLM, and sends the prompt to the LLM, causing the LLM to generate a response. For example, the response may include turkey and cheese skewers, and veggie and hummus wrap.

Responsive to receiving the response from the LLM, the online system 140 conducts a search to identify items that are related to turkey and cheese skewers and veggie and hummus wrap. In some embodiments, the online system 140 also identifies featured items or sponsored content items that are associated with the turkey and cheese skewers and veggie and hummus wrap, and conducts a bidding to identify a highest bidder among all the sponsored content items.

The process of generating a prompt, receiving the response from the LLM, and the bidding process are all performed in the back end, remaining transparent to the users. The output of these processes, which include search results and/or the winner of the sponsored content items, are displayed to the users. As illustrated in FIG. 8, the display includes two carousels; one showcasing products associated with turkey and cheese skewers, and the other showcasing products associated with veggie and hummus wrap. Both sponsored and organic search results are mixed within these carousels. For example, in the turkey and cheese skewers carousel, Swiss cheese is a sponsored item, and in the veggie and hummus wrap, organic carrot bunch are also sponsored items.

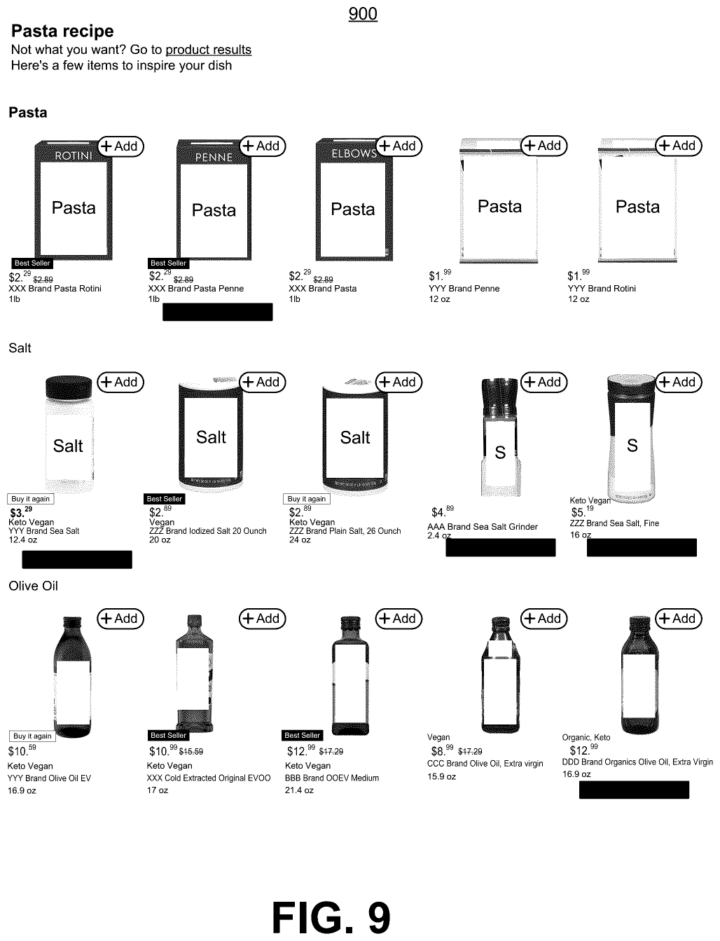

FIG. 9 illustrates another example user interface 900 that presents search results to users in accordance with one or more embodiments. As illustrated in FIG. 9, the user enters “pasta recipe.” Again, in the back end, the online system 140 performs the steps of generating a prompt, sending the prompt to an LLM, causing the LLM to generate a response, receiving the response, conducting a search and bid based on the response. All of these actions are executed in a matter of milliseconds and remain invisible to the user. The outcome, including search results and winning sponsored content, is then shown. As in FIG. 9, the display features three carousels containing various products: one for pasta, one for salt, and one for olive oil. Both sponsored and organic search results are mixed within these carousels.

### Using AI-Based Chatbot for Brand Representation

Companies offer their products or services to customers through different sales channels, such as brick-and-mortar stores, and online stores. Even though online stores have revolutionized the way people shop, brands and retailers still maintain their brick-and-mortar stores in many places.

Unlike traditional brick-and-mortar retail spaces, online platforms lack the presence of brand-specific sales representatives. While many online platforms employ chatbots for basic customer inquiries and automated suggestions, these systems often fall short in delivering nuanced and specialized advice to a brand. The lack of such expert guidance in the online shopping sphere often results in a less enriching and engaging customer experience, as generic customer service options are often unable to fill this void.

Embodiments described herein relate to an online system that solves the above-described problem. In some embodiments, the online system receives a message from a client device of a user via a chatbot interface, and selects one of a plurality of brands based in part on the received message. The online system generates a prompt for input to a machine-learned language model. The prompt specifies at least the message and a request to generate a response based on the message and the selected brand. The prompt is then provided to a model serving system for execution by the machine-learned language model. The online system receives, from the model serving system, a response generated by executing the machine-learned language model on the prompt. The response includes at least promotion of the selected brand. The online system presents the response to the client device of the user via the chatbot interface.

In some embodiments, responsive to receiving a message from a client device of a user via a chatbot interface the online system selects one of a plurality of machine-learned language models based in part on the received messages. Each of the plurality of machine-learned language models is dedicated to a respective brand and is trained or fine-tuned based on content associated with the respective brand. A prompt is then generated for the selected model, incorporating both the received message and a request to formulate a brand-consistent response. This prompt is subsequently sent to a model serving system, which executes the task using the chosen language model. The system then receives back a response from the model serving system, which includes at least some form of brand promotion pertinent to the selected model. Finally, this brand-consistent response is presented to the user's client device via the chatbot interface. In some embodiments, this response includes a message that is in line with the identity of the relevant brand.

In one or more embodiments, the online system 140 provides an interface for a generative language application, e.g., a chatbot, or a Question and answer (Q/A) search box. Responsive to receiving a message from a client device of a user via a chatbot interface, the online system 140 selects one of a plurality of brands based in part on the received message. The online system 140 generates a prompt for input to a machine-learned language model (e.g., an LLM). The prompt specifies at least the message and a request to generate a response based on the message and the selected brand. The prompt is then provided to a model serving system 150 for execution by the machine-learned language model. The online system 140 then receives, from the model serving system 150, a response generated by executing the machine-learned language model on the prompt. The response includes at least a promotion of the selected brand. The online system 140 presents the response to the client device of the user via the chatbot interface.

In some embodiments, the online system 140 uses LLMs to analyze data associated with each brand to identify key themes, messaging, and communication styles. The data associated with each brand may include (but is not limited to) text, images, and multimedia elements. Such data may be obtained from a brand's pages, marketing materials, and/or historical communication histories with customers. The LLMs can also analyze the tone and sentiment of the language used on data associated with each brand to understand the brand's personality and emotional appeal, which can provide insights into the brand's values, positioning, and target audience.

In some embodiments, the LLMs can also compare data associated with a brand with that of its competitors to identify similarities and differences, as well as potential gaps or opportunities in the market. This understanding can be summarized and input into an LLM-powered chatbot and be used to produce a high-quality creative text at the same level as a human who has a very deep understanding about a brand's unique selling proposition.

In some embodiments, data associated with each brand is indexed into an indexed database. The online system 140 may communicate with the interface system 160, which include interfaces between the LLM and the indexed database, causing the LLM to consider both the prompt and the index document in generating the response. In one instance, each brand has its own indexed database. Portions of the indexed database associated with the selected brand are input into the machine-learned model, causing the machine-learned model to consider both the prompt and the portion of the database of the selected brand in generating the response.

In some embodiments, a plurality of machine-learned language models are trained based on content associated with multiple brands, and each model is dedicated to a respective brand. Responsive to receiving a message from a client device of a user via a chatbot interface, the online system 140 selects one of a plurality of machine-learned language models based in part on the received messages. Each of the plurality of machine-learned language models is dedicated to a respective brand and is trained or fine-tuned based on content associated with the respective brand. A prompt is then generated for the selected model, incorporating both the received message and a request to formulate a brand-consistent response. This prompt is subsequently sent to a model serving system, which executes the task using the chosen language model. The system then receives back a response from the model serving system 150, which includes at least some form of brand promotion pertinent to the selected model. This response is then presented to the user's client device via the chatbot interface.

The brand selection module 227 may include a chatbot interface 228 configured to receive messages from client devices of users. Responsive to receiving a message from a client device of a user, the brand selection module 227 is configured to select one of a plurality of brands based in part on the received message, and generate a response based on the selected brand. In some embodiments, the selection of the brand may be based on the content of the message. For example, if the message includes an inquiry about a particular brand, the particular brand may be selected. As another example, if the message includes an inquiry about yoga pants, a sports clothing brand may be selected. Alternatively, or in addition, the selection of the brand may further be based on an auction, and a highest bidder among the plurality brands will be selected.

In some embodiments, the brand selection module 227 uses LLMs to analyze data associated with each brand to identify key themes, messaging, and communication styles. The data associated with each brand may include (but is not limited to) text, images, and multimedia elements. Such data may be obtained from a brand's pages, marketing materials, and/or historical communication histories with customers. The LLMs can also analyze the tone and sentiment of the language used on data associated with each brand to understand the brand's personality and emotional appeal, which can provide insights into the brand's values, positioning, and target audience.

In some embodiments, the LLMs can also compare data associated with a brand with that of its competitors to identify similarities and differences, as well as potential gaps or opportunities in the market. This understanding can be summarized and input into an LLM-powered chatbot and be used to produce a high-quality creative text at the same level as a human who has a very deep understanding about a brand's unique selling proposition.

In some embodiments, data associated with the plurality of brands are indexed into an indexed database. In some embodiments, the indexed database is generated based on LlamaIndex™. In some embodiments, the indexed database is generated based on Langchain™. However, it is appreciated any type of interface system 160 can be used.

In some embodiments, a custom chatbot or agent for each brand may be built using content of the brand and/or the indexed data, such that the custom LLM can act as a salesperson. In some embodiments, the custom chatbot for a particular brand is configured to input portions of a brand-specific indexed database and the user request into an LLM, causing the LLM to consider both the prompt and the data contained in the brand-specific indexed database in generating a response.

In some embodiments, the machine-learned module 230 may include a plurality of machine-learned language models, each of which is dedicated to a respective brand and is trained or fine-tuned based on content associated with the respective brand. In some embodiments, the brand selection module 227 selects one of a plurality of machine-learned language models based in part on the received message. In some embodiments, each custom chatbot is linked to a brand-specific machine-learned language model, causing the brand-specific machine-learned language model to generate a response based on the user request. Moreover, responsive to a user prompt, the brand selection module 227 may identify relevant portions of the indexed database dedicated to that particular brand, and use both the user request and the indexed portion to obtain a response from the LLM dedicated to that particular brand.

In some embodiments, in generating the response, the model may generate a promotion of the selected brand. The promotion may include a logo of the brand, a name of the brand, a mission or vision statement of the brand, a positive perception of the brand, and a positive customer experience of the brand. In some embodiments, the promotion may include a URL that links to a featured product of the brand or a webpage of the brand.

In some embodiments, the model may generate a response in the tone and sentiment associated with the selected brand and/or consistent with the selected brand's personality and emotional appeal. In some embodiments, the model may generate a comparison between the selected brand and a competing brand, and present the advantages of the selected brand over the competing brand. This is because the LLM is fine-tuned or trained based on content specific to that brand that includes characteristics, such as style or tone of messaging for the brand, mission statements for the brand, and the like.

In some embodiments, the brand selection module 227 can identify potential customers, present the brand's products, answer questions about the brand, and persuade the customers to make purchases. Via a chatbot or agent, the brand selection module 227 can also be made available on brand pages or specific product pages related to that brand, which is enticing for brands.

In some embodiments, the generated response is directly passed onto the client device of the user. In some embodiments, the generated response is further modified before being sent to the client device of the user. In some embodiments, the generated response is inserted in a brand template with a specific look and feel consistent with the brand's general impression. In some embodiments, the generated response is modified to include a URL, linking to a product of the brand. In some embodiments, the generated response is modified to include a URL, linking to a brand webpage. In some embodiments, the generated response is modified to further include an interactive element, e.g., a button to add a featured product to a shopping cart.

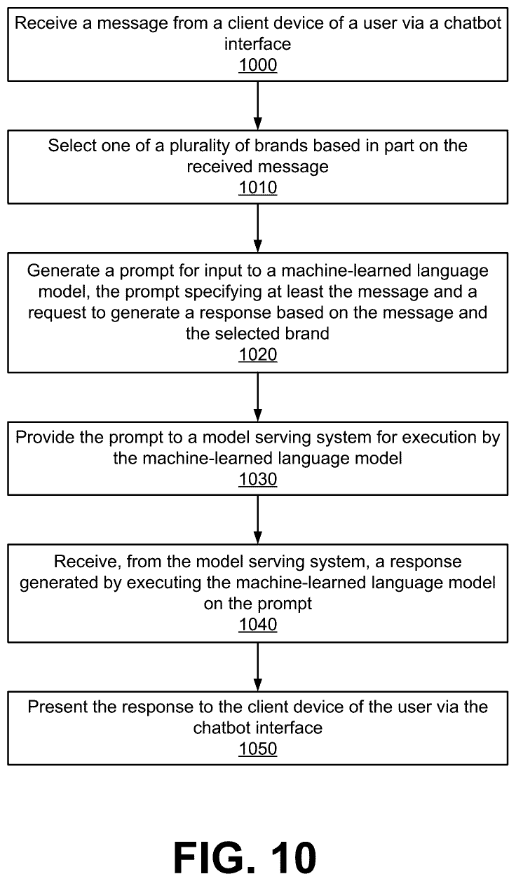

FIG. 10 is a flowchart for a method of responding to user requests with a brand-specific promotion in accordance with one or more embodiments. Alternative embodiments may include more, fewer, or different steps from those illustrated in FIG. 10, and the steps may be performed in a different order from that illustrated in FIG. 10. These steps may be performed by an online system (e.g., online system 140). Additionally, each of these steps may be performed automatically by the online system without human intervention.

The online system 140 receives 1000 a message from a client device of a user via a chatbot interface. The online system 140 selects 1010 one of a plurality of brands based in part on the received message. The selection of the machine-learned language model may be based on the content of the message. For example, if the message includes an inquiry about yoga pants, a sports clothing brand may be selected. Alternatively, or in addition, the selection of the machine learned language model may also be based on an auction result. For example, the plurality of sports clothing brands may participate in an auction, and the machine-learned language model corresponding to the highest bidder is selected.

The online system 140 generates 1020 a prompt for input to a machine-learned language model. The prompt specifies at least the message and a request to generate a response based on the message and the selected brand. An example prompt may be:

You are a [Brand Name] brand salesperson. Please generate a response to the following customer inquiry: [what's a healthy lunch for my kids?]

The online system 140 provides 1030 the prompt to a model serving system for execution by the machine-learned language model. The online system 140 receives 1040, from the model serving system 150, a response generated by executing the machine-learned language model on the prompt. In generating the response, the machine-learned language model may generate a promotion of the selected brand. In some embodiments, the promotion may include a logo of the brand, a name of the brand, a mission or vision statement of the brand, a positive perception of the brand, and a positive customer experience of the brand. In some embodiments, the promotion may include a URL that links to a featured product of the brand or a webpage of the brand. The online system 140 then presents 1050 the response to the client device of the user via the chatbot interface. In some embodiments, the online system collects data on user interactions with the featured products, e.g., whether or not the user adds a featured product to their shopping cart. The collected user interactions may then be used to improve future recommendations. In some embodiments, the data on user interactions may be used to retrain and/or fine-tune a machine-learned model that predicts the click-through rate (CTR) for each product. This prediction helps prioritize items more likely to engage user effectively, giving an advantage to products with higher CTR potential. Alternatively, or in addition, the data on user interactions may be used to retrain and/or fine-tune the machine-learned language model.

In some embodiments, data associated with the plurality of brands are indexed into an indexed database, e.g., based on LlamaIndex™ or Langchain™ as an interface system 160. A custom chatbot or agent for each brand may be built using the indexed data to act as a salesperson. In some embodiments, the custom chatbot is configured to input a brand-specific indexed database and the user message into an LLM, causing the LLM to consider both the user message and the data contained in the brand-specific document in generating a response.

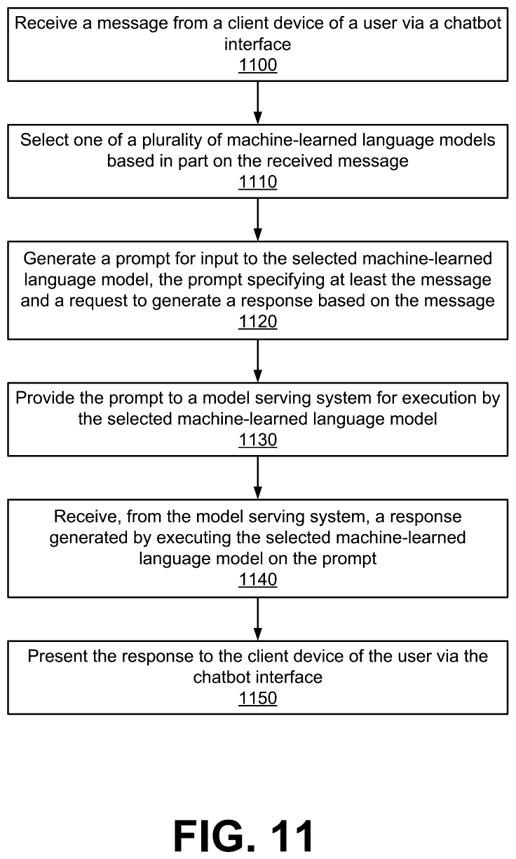

FIG. 11 is a flowchart for another method of responding to user requests with a brand specific promotion in accordance with one or more embodiments. Alternative embodiments may include more, fewer, or different steps from those illustrated in FIG. 11, and the steps may be performed in a different order from that illustrated in FIG. 11. These steps may be performed by an online system (e.g., online system 140). Additionally, each of these steps may be performed automatically by the online system without human intervention.

The online system 140 receives 1100 a message from a client device of a user via a chatbot interface. Responsive to receiving the message from the client device of the user, the online system 140 selects 1110 one of a plurality of machine-learned language models based in part on the received message. Each of the plurality of machine-learned language models is dedicated to a respective brand and is trained or fine-tuned based on content associated with the respective brand.

In some embodiments, each of the plurality of machine-learned language models analyzed data associated with a corresponding brand to identify key themes, messaging, and communication styles. The data associated with each brand may include (but is not limited to) text, images, and multimedia elements. Such data may be obtained from a brand's pages, marketing materials, and/or historical communication histories with customers. The machine-learned language models can also analyze the tone and sentiment of the language used on data associated with each brand to understand the brand's personality and emotional appeal, which can provide insights into the brand's values, positioning, and target audience.

After the machine-learned language model is selected, the online system 140 generates 1120 a prompt for input to the selected machine-learned language model. The prompt specifies at least the message and a request to generate a response based on the message. The prompt is provided 1130 to a model serving system for execution by the selected machine-learned language model. The selected machine-learned model is then applied to the prompt to generate a response, which is sent to the model serving system. The online system 140 receives 1140 the response, from the model serving system. The response includes at least a promotion of the brand corresponding to the selected machine-learned language model. The online system 140 presents 1150 to the client device of the user via the chatbot interface. In some embodiments, the online system 140 collects user interaction on the featured brand, e.g., whether the user clicks the featured brand, or whether the user places a product of the featured brand in a shopping cart. In some embodiments, the data on user interactions may be used to retrain and/or fine-tune a machine-learned model that predicts the click-through rate (CTR) for each brand. This prediction helps prioritize bands and/or items more likely to engage user effectively, giving an advantage to products with higher CTR potential. Alternatively, or in addition, the data on user interactions may be used to retrain and/or fine-tune the machine-learned language model.

In some embodiments, the generated response is directly passed onto the client device of the user. In some embodiments, the generated response is further modified before being sent to the client device of the user. In some embodiments, the generated response is inserted in a brand template with a specific look and feel consistent with the brand's general impression. In some embodiments, the generated response is modified to include a URL, linking to a product of the brand. In some embodiments, the generated response is modified to include a URL, linking to a brand webpage. In some embodiments, the generated response is modified to further include an interactive element, e.g., a button to add a featured product to a shopping cart.

In some embodiments, the generated response is in the tone and sentiment associated with the selected brand and/or consistent with the selected brand's personality and emotional appeal. In some embodiments, the generated response may further include a comparison between the selected brand and a competing brand, presenting the advantages of the selected brand over the competing brand.

Referring back to FIG. 8, the user interface 800 includes a search box or a Q/A box, allowing users to input search terms or questions. For example, if a user enters “what's a healthy lunch for my kids?”, the online system selects a brand among multiple brands, and generates a prompt for an LLM, and sends the prompt to the LLM, causing the LLM to generate a response representing the selected brand. Responsive to receiving the response from the LLM, the online system 140 presents the response to the user.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from a client device and via an interface, a user query;
identifying one or more featured products based on the user query;
generating a prompt for input to a machine-learned generative language model, the prompt specifying at least a request related to the user query and a request to suggest the one or more featured products in association with a response to the prompt;
providing the prompt to a model serving system for execution by the machine-learned generative language model;
receiving, from the model serving system, a response generated by executing the machine-learned generative language model on the prompt, the response including at least one of the one or more featured products;
generating a query response to the user query based on the response generated by executing the machine-learned generative language model on the prompt, the query response including at least a suggestion for the at least one of the one or more featured products;
transmitting instructions, to the client device, to cause display of the generated query response to the user;
receiving and collecting data on user interactions with the query response; and
fine-tuning the machine-learned generative language model based on the collected data on user interactions with the query response.

2. The method of claim 1, further comprising:
generating a respective relevance score for each of a set of candidate featured products, the relevance score indicating a level of relevance of a respective featured product to the user query; and
selecting the one or more featured products having relevance scores above a threshold for inclusion in the prompt.

3. The method of claim 1, further comprising:
receiving a bid value from each of a plurality of product providers that offer a set of candidate featured products; and
selecting the one or more featured products having bid values above a threshold for inclusion in the prompt.

4. The method of claim 1, wherein generating the query response comprises generating a recipe page including a list of products for fulfilling the recipe, wherein the list of products includes the one or more featured products.

5. The method of claim 1, wherein generating the query response comprises generating textual content incorporating the suggestion for the one or more featured products in the textual content.

6. The method of claim 1, further comprising:
receiving a second user query from a second client device;
generating a second prompt for input to the machine-learned generative language model, the second prompt specifying at least a second request related to the second user query and a second request to include one or more consumer packaged good (CPG) products in a response; and
receiving a second response generated by executing the machine-learned generative language model on the second prompt, the second response including the one or more CPG products.

7. The method of claim 6, further comprising:
generating a second query response to the second user query by mapping the one or more CPG products to one or more products in a catalog of an online system; and
transmitting instructions to the second client device to cause presentation of the one or more mapped products to a second user.

8. The method of claim 7, wherein generating the second query further comprises:
mapping a CPG product to a set of candidate products;
receiving a bid value for each candidate product in the set of candidate products; and
performing an auction process to select a product from the set of candidate products having a bid value above a threshold.

9. The method of claim 1, wherein generating the suggestion for the one or more featured products includes creating hyperlinks associated with the products, allowing direct interaction with the featured products within the response.

10. A non-transitory computer-readable medium, having instructions encoded thereon that, when executed by one or more processors, cause the one or more processors to perform steps comprising:
receiving, from a client device and via an interface, a user query;
identifying one or more featured products based on the user query;
generating a prompt for input to a machine-learned generative language model, the prompt specifying at least a request related to the user query and a request to suggest the one or more featured products in association with a response to the prompt;
providing the prompt to a model serving system for execution by the machine-learned generative language model;
receiving, from the model serving system, a response generated by executing the machine-learned generative language model on the prompt, the response including at least one of the one or more featured products;
generating a query response to the user query based on the response generated by executing the machine-learned generative language model on the prompt, the query response including at least a suggestion for the at least one of the one or more featured products;
transmitting instructions, to the client device, to cause display of the generated query response to the user;
receiving and collecting data on user interactions with the query response; and
fine-tuning the machine-learned generative language model based on the collected data on user interactions with the query response.

11. The non-transitory computer-readable medium of claim 10, further comprising:
generating a respective relevance score for each of a set of candidate featured products, the relevance score indicating a level of relevance of a respective featured product to the user query; and
selecting the one or more featured products having relevance scores above a threshold for inclusion in the prompt.

12. The non-transitory computer-readable medium of claim 10, the steps further comprising:
receiving a bid value from each of a plurality of product providers that offer a set of candidate featured products; and
selecting the one or more featured products having bid values above a threshold for inclusion in the prompt.

13. The non-transitory computer-readable medium of claim 10, wherein generating the query response comprises generating a recipe page including a list of products for fulfilling the recipe, wherein the list of products includes the one or more featured products.

14. The non-transitory computer-readable medium of claim 10, wherein generating the query response comprises generating textual content incorporating the suggestion for the one or more featured products in the textual content.

15. The non-transitory computer-readable medium of claim 10, the steps further comprising:
receiving a second user query from a second client device;
generating a second prompt for input to the machine-learned generative language model, the second prompt specifying at least a second request related to the second user query and a second request to include one or more consumer packaged good (CPG) products in a response; and
receiving a second response generated by executing the machine-learned generative language model on the second prompt, the second response including the one or more CPG products.

16. The non-transitory computer-readable medium of claim 15, the steps further comprising:
generating a second query response to the second user query by mapping the one or more CPG products to one or more products in a catalog of an online system; and
transmitting instructions to the second client device to cause presentation of the one or more mapped products to a second user.

17. The non-transitory computer-readable medium of claim 16, wherein generating the second query further comprises:
mapping a CPG product to a set of candidate products;
receiving a bid value for each candidate product in the set of candidate products; and
performing an auction process to select a product from the set of candidate products having a bid value above a threshold.

18. The non-transitory computer-readable medium of claim 10, wherein the suggestion for the one or more featured products includes hyperlinks associated with the one or more featured products, enabling the user to directly interact with the one or more featured products from within the response.

19. A computing system, comprising:
one or more processors;
non-transitory computer-readable medium, having instructions encoded thereon that, when executed by the one or more processors, cause the one or more processors to perform steps comprising:
receiving, from a client device and via an interface, a user query;
identifying one or more featured products based on the user query;
generating a prompt for input to a machine-learned generative language model, the prompt specifying at least a request related to the user query and a request to suggest the one or more featured products in association with a response to the prompt;
providing the prompt to a model serving system for execution by the machine-learned generative language model;
receiving, from the model serving system, a response generated by executing the machine-learned generative language model on the prompt, the response including at least one of the one or more featured products;
generating a query response to the user query based on the response generated by executing the machine-learned generative language model on the prompt, the query response including at least a suggestion for the at least one of the one or more featured products;
transmitting instructions, to the client device, to cause display of the generated query response to the user;
receiving and collecting data on user interactions with the query response; and
fine-tuning the machine-learned generative language model based on the collected data on user interactions with the query response.

20. The computing system of claim 19, the steps further comprising:
generating a respective relevance score for each of a set of candidate featured products, the relevance score indicating a level of relevance of a respective featured product to the user query; and
selecting the one or more featured products having relevance scores above a threshold for inclusion in the prompt.
